(19) United States
(12) Patent Application Publication
(10) Pub. No.: US 2013/0247614 A1
(43) Pub. Date: Sep. 26, 2013

(54) METHOD AND APPARATUS FOR ATTACHING STONES TO NON-METAL MOUNTS

(71) Applicant: Nicolas Charles THOMAS, Bangkok (TH)

(72) Inventor: Nicolas Charles THOMAS, Bangkok (TH)

(21) Appl. No.: 13/429,427

(22) Filed: Mar. 25, 2012

(51) Int. Cl. A44C 17/02; B32B 7/04

(52) U.S. Cl. 63/29.1; 63/26; 156/91

(57) ABSTRACT

A method or apparatus for securing a first stone to a non-metal mount, the mount comprising a base and a cap which, in cooperation with the base, prevents the first stone from being lost. The first stone may be one of a crystal, a gemstone, a birthstone, a gem, or a similar item. The base may be attached to the cap through the use of screws, snaps, Velcro, glue or a thread connection between the base and the cap. The base may include an elevated pedestal on which the first stone rests, and the elevated pedestal may be configured such that a portion of the first stone extends outside of said cap. The base/cap combination may securely affix the stone between the base and the cap, or it may be designed such that the stone may move between the base and the cap.

### FIELD OF THE INVENTION

The present invention relates generally to a method and apparatus for attaching crystals, gemstones, birthstones, gems, or similar items (collectively “stones”) to non-metal (such as plastic) mounts.

### BACKGROUND OF THE INVENTION

When crystals, gemstones, birthstones, gems, or similar items, (collectively “stones”) are set in a metal mount, it is common for the metal mount, or portions of the metal mount, to be reshaped to ensure that the stone is securely restrained in the metal mount. This process is typically performed by a jeweler when he/she sets a stone in jewelry such as a necklace or a ring. For example, the metal mount included in a ring may consist of three, four, five, or six metal prongs which the jeweler reshapes to ensure that the stone is securing restrained within the metal mount. However, when a non-metal (such as plastic) mount is used, oftentimes the non-metal mount cannot be reshaped to ensure that the stone is securely restrained within the non-metal mount. Heretofore, adhesives such as glue have been used to attach the stone to the non-metal mounts, or to portions of the non-metal mount. Unfortunately, many stones are lost when the adhesive fails and the stone falls from the non-metal mounts. One example of these non-metal mounts is a plastic mounts. If a jeweler attempts to reshape the prongs of a plastic mount, the prongs typically break off.

### SUMMARY OF THE INVENTION

In one embodiment, the invention includes an apparatus for securing a first stone to a non-metal mount, the mount comprising a base and a cap which, in cooperation with the base, prevents the first stone from being lost. The first stone may be one of a crystal, a gemstone, a birthstone, a gem, or a similar item. The base may be attached to the cap through the use of screws, snaps, Velcro, glue or a thread connection between the base and the cap. The base may include an elevated pedestal on which the first stone rests, and the elevated pedestal may be configured such that a portion of the first stone extends outside of said cap. The base/cap combination may securely affix the stone between the base and the cap, or it may be designed such that the stone may move between the base and the cap. The mount may also be designed to permit a user to remove the cap from the base and to replace the first stone with a second stone. In other embodiments, one, or more, inner sections of the cap are shaped to conform to the outside portions of the first stone.

In another embodiment, the invention includes a method of retaining a stone within a non-metal mount, the method comprising the steps of: positioning a first stone in a base of the mount, and affixing a cap of the mount to the base such that the first stone is retained in the space between the base and the cap.

### BRIEF DESCRIPTION OF THE DRAWINGS

In the drawings, like reference characters generally refer to the same parts throughout the different views. The drawings are not necessarily to scale, but rather the emphasis is generally being placed upon illustrating the principles of various embodiments. The foregoing and other aspects of the invention will be better understood from the following description of embodiments of the invention, by way of example only, and with reference to the accompanying drawings, in which:

FIG. 1 is an exploded perspective view of a first embodiment of the present invention;

FIG. 2 is a partially exploded perspective view of the first embodiment of the present invention;

FIG. 3 is a perspective view of a first embodiment of the present invention;

FIG. 4 is an exploded side view of a first embodiment of the present invention;

FIG. 5 is a partially exploded side view of the first embodiment of the present invention;

FIG. 6 is a side view of a first embodiment of the present invention;

FIG. 7 is an exploded side view of the apparatus for attaching a stone to a non-metal setting; and

FIG. 8 is a side view of the apparatus of FIG. 7.

### DETAILED DESCRIPTION OF THE INVENTION

In the following detailed description, reference will be made in detail to the preferred embodiments of the present invention, examples of which are illustrated in the accompanying drawings, which form a part hereof and show by way of illustration embodiments in which the invention may be practiced. These embodiments are described in sufficient detail to enable those skilled in the art to practice the invention, and it is to be understood that other embodiments may be utilized, and that structural, and logical changes may be made without departing from the spirit and scope of the present invention. The progression of processing steps described is exemplary of embodiments of the invention; however, the sequence of steps is not limited to that set forth herein and may be changed as is known in the art, with the exception of steps necessarily occurring in a certain order.

While crystals, gemstones, birthstones, gems, or similar items, (collectively “stones”) have been used in jewelry for decades, over the last few years the use of stones has been expanded to include decorations on a plethora of items including, but not limited to, rings, necklaces, bracelets, headbands, clothing, mobile phone cases, watches, purses, dog collars, etc. In many of these settings the mount and the attached stone is subject to harsh treatment such as when an article of clothing adorned with one or more stones is washed in a washing machine and dried in a dryer.

Prior to the present invention, the most reliable and dependable method of securing a stone to its mount was to use a metal mount and to reshape the metal mount, or to reshape portions of the metal mount (such as the metal prongs of a ring), so that the stone was physically constrained by the mount or a portion thereof. While this method of reshaping the mount to attach a stone was acceptable when a metal mount was used, it could not be used when a non-metal, such as a plastic mount, was used. If a jeweler attempted to reshape many types of non-metal mounts, such as a plastic mount, to physically constrain the stone, the mount, or a portion of the mount, would break. Jewelers and others that wished to attach a stone to a non-metal mount had to resort to gluing the stone to the non-metal mount. However, all too often the adhesive used to glue the stone to the non-metal mount would deteriorate over time and the stone would fall out and be lost.

The present invention consists of a method and an apparatus, entitled an Interlocking Stone Setting Solution (abbreviated “IS³”), which may be used to secure one or more stones to non-metal mounts.

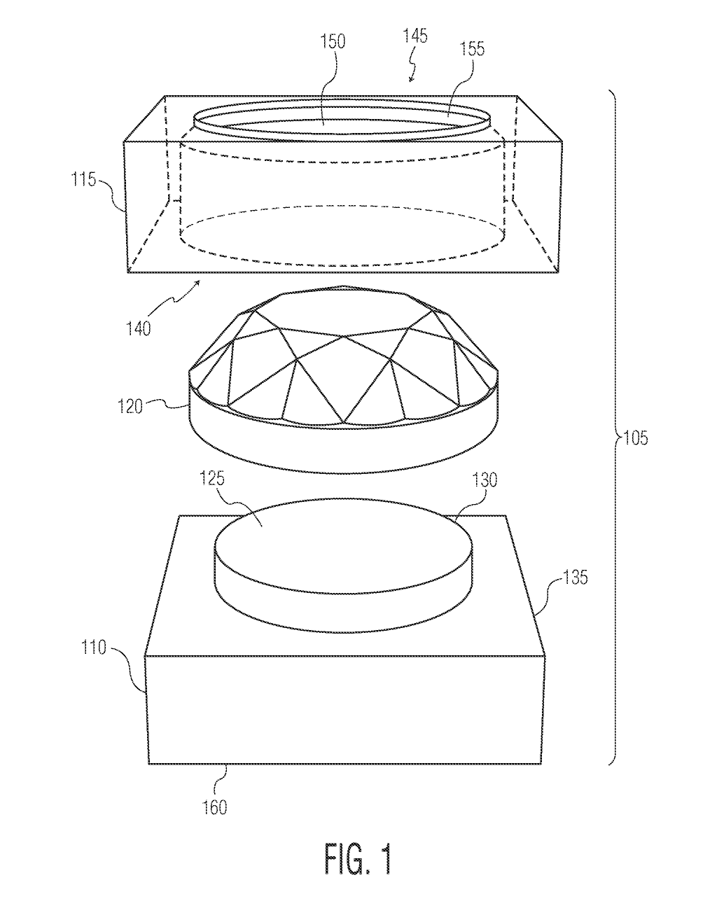

FIG. 1 illustrates a perspective view of a preferred embodiment of IS³ 105 which utilizes a base 110 and a cap 115 to “sandwich” the stone 120 between the base 110 and the cap 115 to securely affix stone 120 to the mounting. In one embodiment, the base 110 includes an elevated pedestal 125 which provides a platform on which the stone 120 rests. While FIG. 1 shows an elevated pedestal 125 with a circular outside circumference 130, other shapes may be used. Additionally, the thickness (or height) of the elevated pedestal 125 may be adjust such that the stone 120 is placed in a desired location with respect to cap 115. A thicker (or higher) pedestal will elevate the top of the stone 120 with respect to the top of cap 115 while a thinner (or lower) pedestal will position the stone in a lower orientation to cap 115. Depending on the thickness of the stone 120 and the vertical depth of cap 115, a pedestal 125 may not be required. While the outside circumference 135 of base 110 is shown to be a square in FIG. 1, one of ordinary skill in the art would understand that any shape may be used.

Cap 115 includes both a bottom opening 140 and a top opening 145. Bottom opening 140 is typically configured so that both the stone 120 and the top portion of the base 110 may enter into the bottom opening 140 of cap 115. Top opening 145 is normally configured so that a portion of the stone 120 either extends through top opening 145, or so that a portion of stone 120 is visible through top opening 145. In addition, cap 115 may include one or more surfaces configured to match the outer surfaces of stone 120. For example, in the preferred embodiment shown in FIG. 1, cap 115 includes both a circular inner circumference 150 and a beveled section 155 which match the outer surface of stone 120.

Cap 115 “locks” to base 110 to ensure stone 120 is not inadvertently lost. Cap 115 may lock to base 110 through a variety of fastening means, including, but not limited to, screws, snaps, Velcro, glue, a threaded connection between base 110 and cap 115, form fitting, or any other method which ensures a secure connection between base 110 and cap 115. In another embodiment, the connection between cap 115 and base 110 may permit stone 120 to move slightly. In one embodiment the connection between cap 115 and base 110 permits stone 120 to be rotated about its center axis. For example, if cap 115 and base 110 are configured to hold a stone on a necklace and the stone includes a vertical line in one orientation, the stone may be rotated such that the line becomes horizontal in a second orientation.

The bottom 160 of base 110 may be configured to wrap around items such that the bottom of base 110 will serve to attach base 110 to different objects. For example, the bottom of base 110 may take the shape of a cellular phone in that the shape of the bottom 160 of base 110 securely wraps around the phone. In other embodiments the bottom 160 of base 110 is formed into a product resulting in secure attachment between the base 110 and the product. Base 110 may be attached in this manner to, for example and without limitation, phone cases, rings, pen covers, bags, shoes, etc. In some embodiments dozens, if not hundreds, of bases 110 are attached to a product such that dozens, if not hundreds, of stones can be attached to the product.

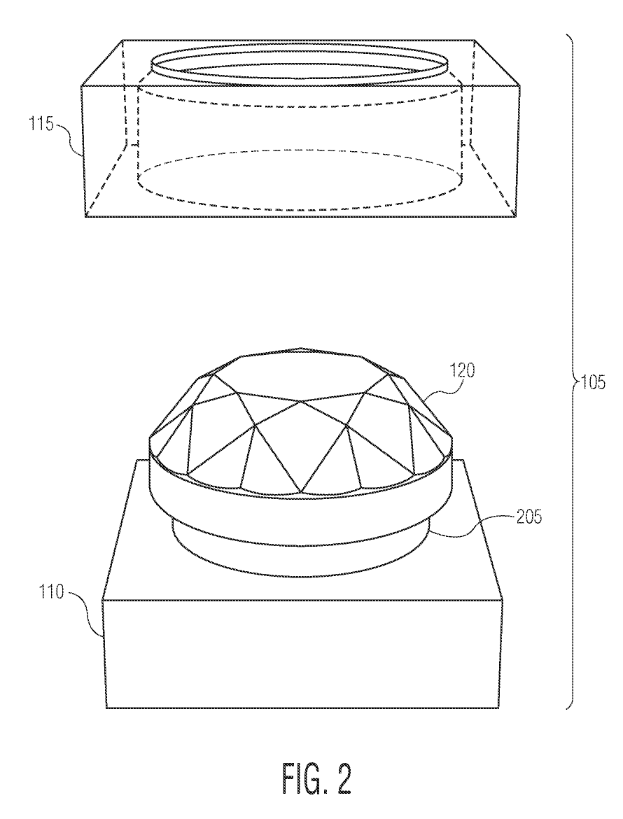

FIG. 2 illustrates a perspective view of the preferred embodiment of IS³ 105 in which stone 120 rests on top of elevated pedestal 125. As shown in this embodiment a portion of the vertical side wall 205 of the elevated pedestal 125 is not covered by stone 120. In other embodiments, stone 120 may be configured to completely cover elevated pedestal 125, including the vertical side walls 205 of elevated pedestal 125.

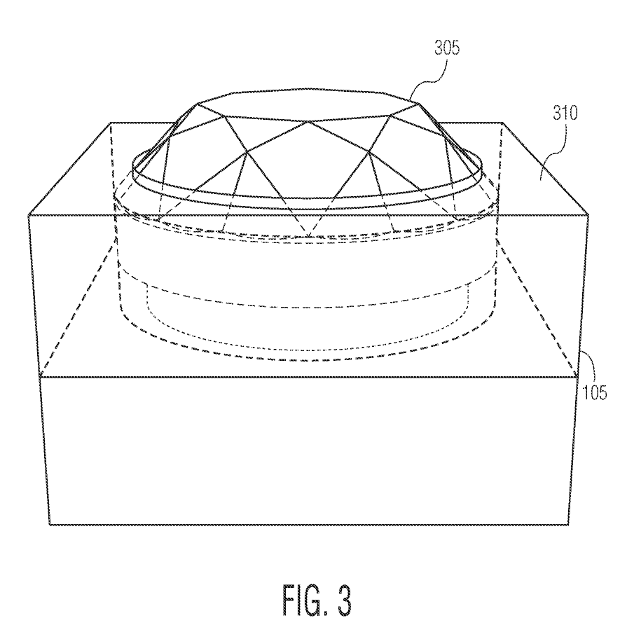

FIG. 3 illustrates a perspective view of the preferred embodiment of IS³ 105 in which stone 120 is resting on top of elevated pedestal 125, and cap 115 is locked on base 110.

As can be seen in FIG. 3, in the preferred embodiment a portion 305 of stone 120 extends above the top 310 of cap 115. As can also be seen in FIG. 3, in the preferred embodiment, the inside of cap 115 is configured to match the outer shape of stone 120. However, one of ordinary skill in the art would appreciate that the inside of cap 115 does not necessarily need to match the outer shape of stone 120, all that is required to practice the current invention is that the cap 115 retains the stone 120 with respect to base 110.

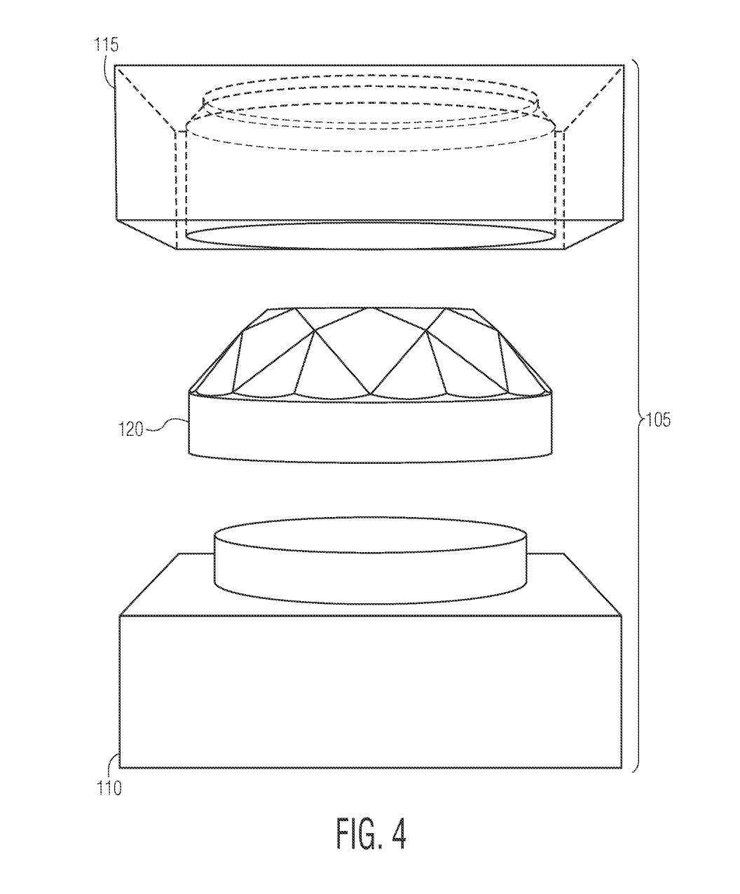

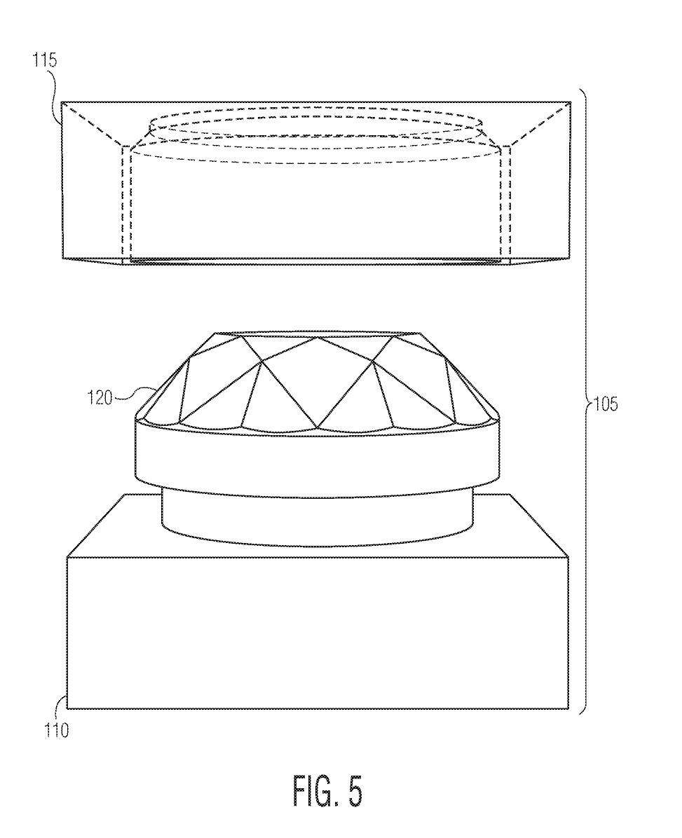

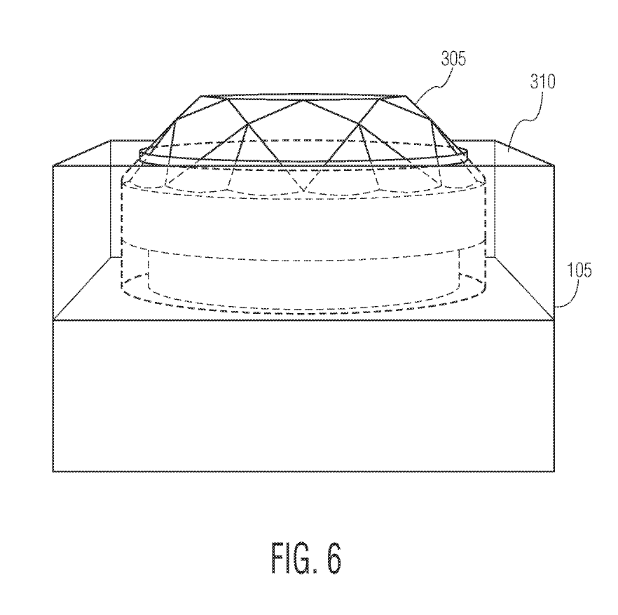

FIGS. 4, 5, and 6 show side views of IS³ 105 which correspond to FIGS. 1, 2, and 3 respectively.

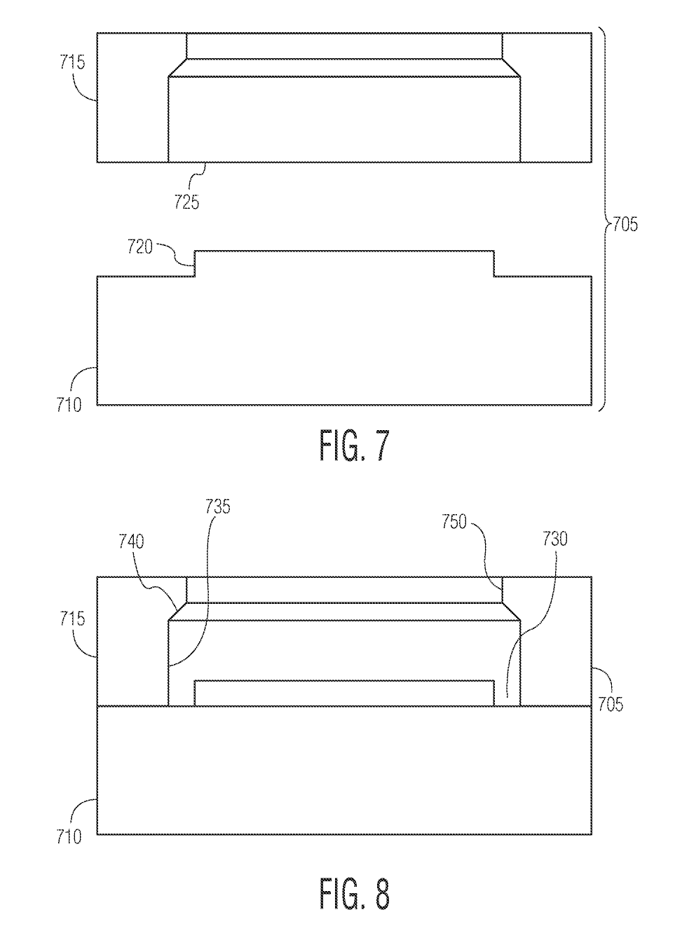

FIGS. 7 and 8 illustrate IS³ 705 with the stone removed. FIGS. 7 and 8 include base 710 and cap 715. FIGS. 7 and 8 also illustrate how the top portion 720 of base 710 fits within the bottom opening 725 of cap 715. As shown in FIG. 8, in one embodiment, a gap 730 may exist, between the top portion 720 of base 710 and the bottom opening 725 of cap 715. As also shown in FIGS. 7 & 8 the inner portions of cap 715 may include portions of various shapes or configurations. For example, and without limitation, the inner portion of cap 715 includes an opening with a circumference of a first diameter 735, a chamfered opening 740, and an opening with a circumference of a second diameter 750.

While the invention has been particularly shown with reference to specific embodiments, it should be understood by those of ordinary skill in the art that various changes in form and detail may be made therein without departing from the spirit and scope of the invention as defined by the claims. The invention is to cover all modifications, equivalents, and alternatives falling within the spirit and scope of the invention as defined by the claims.

1. An apparatus for securing a first stone to a non-metal mount, said mount comprising:
a base, and
a cap which, in cooperation with said base, prevents the first stone from being lost.

2. The apparatus of claim 1 wherein the first stone is one of a crystal, a gemstone, a birthstone, and a gem.

3. The apparatus of claim 1 wherein said base is attached to said cap by one of screws, snaps, Velcro, glue and a thread connection between said base and said cap.

4. The apparatus of claim 1 wherein said base includes an elevated pedestal on which said first stone rests.

5. The apparatus of claim 4 wherein said elevated pedestal is used to position said first stone so that a portion of said first stone extends outside of said cap.

6. The apparatus of claim 1 wherein said first stone is securely affixed between said base and said cap such that said first stone does not move with respect to said cap.

7. The apparatus of claim 1 wherein said cooperation between said base and said cap permits said first stone to move with respect to said cap.

8. The apparatus of claim 1 wherein said apparatus permits a user to separate said cap from said base and to replace said first stone with a second stone.

9. The apparatus of claim 1 wherein a first inner portion of said cap is shaped to conform to a first shape of said first stone.

10. The apparatus of claim 9 wherein a second portion of said cap is shaped to conform to a second shape of said first stone.

11. The apparatus of claim 1 wherein a bottom portion of said base attaches said base to another object.

12. A method of retaining a stone within a non-metal mount, said method comprising the steps of:
positioning a first stone in a base of said mount, and
affixing a cap of said mount to said base such that the first stone is retained in the space between said base and said cap.

13. The method of claim 12 wherein said step of affixing said cap to said base is accomplished by one of screws, snaps, Velcro, glue and a thread connection between said base and said cap.

14. The method of claim 12 wherein an elevated pedestal is included in said base and said step of positioning said first stone in said base includes positioning said stone on said elevated pedestal of said base.

15. The method of claim 14 wherein said step of positioning said stone on said elevated pedestal results in a portion of said first stone extending beyond the top of said cap.

16. The method of claim 12 further including the step of:
securely positioning said first stone between said base and said cap such that said first stone does not move with respect to said cap.

17. The method of claim 12 further including the step of:
non-securely positioning said first stone between said base and said cap such that said first stone is permitted to move with respect to said cap.

18. The method of claim 12 further including the step of:
permitting a user to separate said cap from said base and to replace said first stone with a second stone.

19. The method of claim 12 further including the step of:
shaping a first inner portion of said cap to conform to a first shape of said first stone.

20. The method of claim 19 further including the step of:
shaping a second inner portion of said cap to conform to a second shape of said first stone.
